(19) United States
(12) Patent Application Publication
(10) Pub. No.: US 2026/0333262 A1
(43) Pub. Date: Oct. 22, 2026

(54) COMMUNICATION DEVICE SYSTEM, COMMUNICATION DEVICE, COMMUNICATION DEVICE CONTROL METHOD, AND PROGRAM

(71) Applicant: Panasonic Intellectual Property Management Co., Ltd., Osaka (JP)

(72) Inventors: NORIAKI IMAOKA, Osaka (JP); FUKI KOBAYASHI, Osaka (JP)

(21) Appl. No.: 19/468,228

(22) Filed: Feb. 3, 2026

Related U.S. Application Data
(63) Continuation of application No. PCT/JP2024/033237, filed on Sep. 18, 2024.

(30) Foreign Application Priority Data
Oct. 13, 2023 (JP) 2023-177438

(51) Int. Cl. H04W 56/00

(52) U.S. Cl. CPC H04W 56/002

(57) ABSTRACT

A communication device system includes multiple communication devices, and each communication device includes: a movable unit that switches whether to accept an operation; a communicator that transmits synchronization information indicating a posture of the movable unit changed based on the operation accepted by the movable unit to another communication device among the multiple communication devices and receives the synchronization information from the other communication device; and a control unit that shifts the communication device from a state in which the operation on the movable unit is accepted to a state in which the operation on the movable unit is not accepted for a predetermined time after the synchronization information is received from the other communication device.

### TECHNICAL FIELD

The present disclosure relates to a communication device system including a plurality of communication devices, a communication device included in the communication device system, a communication device control method, and a program.

### BACKGROUND ART

Conventionally, as a method of communication performed remotely by a person and a person, there are a letter, a phone call, an e-mail, a social networking service (SNS), and the like. With the spread of mobile phones, personal computers, and smartphones, these communications can be easily performed. In addition, such a communication method can transmit various kinds of information such as characters, voices, images, and moving images.

On the other hand, the recipient who has received the information from the transmitter side may have a sense of obligation to reply. In addition, the transmitter may feel anxious if there is no reply from the recipient after the information transmission. In a case in which such a sense of obligation or anxiety increases, the service user may avoid communication itself.

In order to solve such a problem, a technique has been developed that prevents users from having a sense of obligation and a sense of anxiety while appropriately maintaining the amount of information of communication. For example, Patent Literature 1 discloses a bidirectional communication device system in which two bidirectional communication devices are installed remotely, and when one user changes the state of one bidirectional communication device, the other bidirectional communication device also changes the state in synchronization with the change.

### Citation List

### Patent Literature

PTL 1: International Publication No. 2023/062919

### SUMMARY OF THE INVENTION

In a method disclosed in PTL 1, changes in states of multiple persons are respectively presented as different state changes of the communication devices, and thereby pieces of information on the state changes are exchanged with each other. On the other hand, as communication, it is also desired to exchange information with multiple persons throwing the same topic together with emotions. However, in order to realize the exchange, it is necessary to present information by multiple persons each performing a state change on the communication device by the same input operation method, and there is a demand for a technique capable of suitably communicating even in a case in which multiple persons accidentally perform input operations simultaneously.

An object of the present disclosure is to provide a communication device system, a communication device, a communication device control method, and a program capable of suitably performing communication even in a case in which multiple users accidentally perform input operations simultaneously.

A communication device system according to an aspect of the present disclosure is a communication device system including multiple communication devices, in which each communication device includes: a movable unit that switches whether to accept an operation; a communicator that transmits synchronization information indicating a posture of the movable unit changed based on the operation accepted by the movable unit to another communication device among the multiple communication devices and receives the synchronization information from the other communication device; and a control unit that shifts the communication device from a state in which the operation on the movable unit is accepted to a state in which the operation on the movable unit is not accepted for a predetermined time after the synchronization information is received from the other communication device.

A communication device according to an aspect of the present disclosure is a communication device that communicates with another communication device, the communication device including: a movable unit that switches whether to accept an operation; a communicator that transmits synchronization information for synchronizing a posture of the movable unit based on the operation accepted by the movable unit to the other communication device and receives the synchronization information from the other communication device; and a control unit that shifts the communication device from a state in which the operation on the movable unit is accepted to a state in which the operation on the movable unit is not accepted for a predetermined time after the synchronization information is received from the other communication device.

A communication device control method according to an aspect of the present disclosure is a communication device control method executed by a computer included in a communication device that communicates with another communication device, the method including: accepting an operation in a state in which the operation on a movable unit included in the communication device is accepted; transmitting synchronization information indicating a posture of the movable unit changed based on the operation to the other communication device; receiving the synchronization information from the other communication device in a state in which an operation on the movable unit included in the communication device is accepted; and shifting the communication device from a state in which the operation on the movable unit is accepted to a state in which the operation on the movable unit is not accepted for a predetermined time after the synchronization information is received from the other communication device.

A program according to an aspect of the present disclosure is a program executed by a computer included in a communication device that communicates with another communication device, the program including causing the computer to execute: a procedure of transmitting synchronization information to the other communication device when an operation is accepted in a state in which the operation on a movable unit included in the communication device is accepted, the synchronization information indicating a posture of the movable unit changed based on the operation; and a procedure of shifting the communication device from a state in which an operation on a movable unit is accepted to a state in which the operation on the movable unit is not accepted for a predetermined time after receiving the synchronization information from the other communication device in a state in which the operation on the movable unit included in the communication device is accepted.

According to the present disclosure, even when multiple users accidentally perform input operations simultaneously in the same input method, communication can be suitably performed.

### BRIEF DESCRIPTION OF THE DRAWINGS

FIG. 1A is a diagram for describing a communication device.

FIG. 1B is a diagram for describing the communication device.

FIG. 2 is a block diagram illustrating a functional configuration of the communication device.

FIG. 3 is a schematic diagram of a communication device system.

FIG. 4 is a state transition diagram of the communication device including a first state, a second state, and a third state.

FIG. 5 is a flowchart for describing an operation example of the communication device.

FIG. 6 is a sequence diagram for describing a first operation example in which a first communication device and a second communication device cooperate with each other.

FIG. 7 is a sequence diagram for describing a second operation example in which the first communication device and the second communication device cooperate with each other.

FIG. 8 is a schematic diagram illustrating a first modification of the communication device system including a relay device.

FIG. 9 is a flowchart for describing an operation example of the relay device.

FIG. 10 is a sequence diagram for describing an operation example in a first modification.

FIG. 11 is a state transition diagram in a second modification of the communication device including a first state, a second state, a third state, and a fourth state.

FIG. 12 is a flowchart for describing an operation example regarding the fourth state of the communication device in the second modification.

FIG. 13 is a flowchart for describing a start-up operation of the communication device.

FIG. 14 is a block diagram illustrating an example of a hardware configuration of a communication device or a relay device.

### DESCRIPTION OF EMBODIMENTS

Hereinafter, exemplary embodiments of the present disclosure will be described in detail with reference to the drawings.

### Configuration of communication device 10

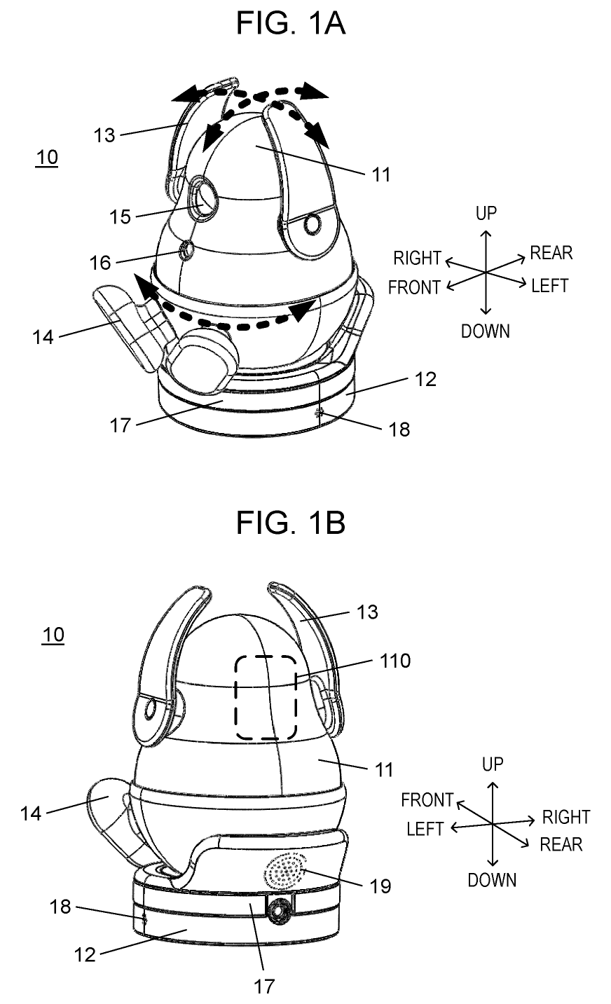

FIG. 1 is a diagram for describing communication device 10 according to an exemplary embodiment of the present disclosure. FIG. 1A is a perspective view of communication device 10 as viewed from an oblique front side, and FIG. 1B is a perspective view of communication device 10 as viewed from an oblique rear side.

In the present exemplary embodiment, as illustrated in FIG. 1, communication device 10 is formed in a robot shape. A computer is built in communication device 10, and communication device 10 can perform a predetermined operation in accordance with a program stored in advance.

In the example illustrated in FIG. 1, communication device 10 includes main body 11, base 12, arms 13, legs 14, eye 15, camera 16, LED 17, microphone 18, speaker 19, and heater 110.

Main body 11 is a portion corresponding to the trunk of communication device 10 having a robot shape. Main body 11 is connected to base 12 in a state of being movable along three axes. The three axes about which main body 11 can move are a front-rear axis, a left-right axis, and an up-down axis when the side on which eye 15 of communication device 10 is provided is defined as a front side. Main body 11 can rotate (yaw) about the front-rear axis, rotate (pitch) about the left-right axis, and rotate (roll) about the up-down axis with respect to base 12.

The user can rotate main body 11 about any one of these three axes by holding and moving a part of main body 11. In the following description, rotation of main body 11 by the user is referred to as user's operation.

After the user's operation is performed, main body 11 maintains the posture finally taken by main body 11 due to the operation. As a specific example, when the user performs an operation of pitching main body 11 forward and finally tilts main body 11 forward, main body 11 maintains the forward-tilted posture finally taken by the user's operation.

Furthermore, main body 11 can take an optional posture by movable unit 101 to be described later under the control of controller 103 to be described later.

Arms 13 and legs 14 are attached to main body 11. Arms 13 and legs 14 may be movably mounted relative to main body 11.

Eye 15 is provided on the front surface of robot shaped communication device 10 to remind the user of the face of the robot. Eye 15 may include a display device such as a liquid crystal display or an organic EL display.

Camera 16 is a camera for recognizing a user.

LED 17 is provided on a part of base 12, and can shine in various lighting manners or in various colors to notify an operation state of communication device 10.

Microphone 18 is a voice input device for acquiring the voice of the user.

Speaker 19 notifies the user by sound.

Heater 110 can make the user feel warm when touched by the user. In the example illustrated in FIG. 1, heater 110 is provided on the rear side of the main body 11, but in the present disclosure, the position of heater may be another position (for example, an upper end portion of the movable unit or the like).

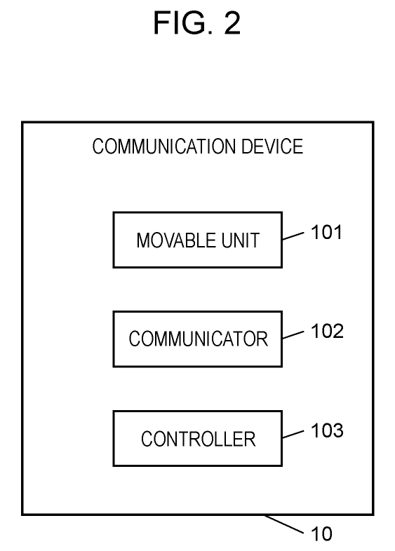

FIG. 2 is a block diagram illustrating an example of a functional configuration implemented by a computer built in communication device 10.

As illustrated in FIG. 2, communication device 10 includes movable unit 101, communicator 102, and controller 103.

Movable unit 101 is a mechanism for moving main body 11 illustrated in the figure. Movable unit 101 is configured with, for example, a motor. Movable unit 101 can cause main body 11 to maintain a constant posture. Furthermore, movable unit 101 can move main body 11 and cause main body 11 to take a desired posture in accordance with the control of controller 103.

Furthermore, movable unit 101 can include a sensor that reads user's operation content (operation direction, operation amount, etc.) on main body 11. Controller 103 can further include a computer that generates information (synchronization information) regarding the posture finally taken by movable unit 101 (main body 11) by the user's operation. The synchronization information is, for example, information indicating how many degrees and around which axis main body 11 has been rotated from the initial posture (posture in which main body 11 does not rotate about any of the front-rear axis, the left-right axis, and the up-down axis).

Movable unit 101 can switch whether to accept a user's operation on main body 11. In the present description, accepting an operation means that when a user applies a force to main body 11, main body 11 is allowed to move in accordance with the force, and controller 103 generates synchronization information regarding the posture taken by main body 11 as a result of the operation. The posture of main body 11 is the same as the posture of movable unit 101. In addition, in the present description, not accepting an operation means not generating synchronization information based on the force when the user applies the force to main body 11.

When movable unit 101 does not accept the user's operation, movable unit 101 may apply a force in a direction opposite to the force applied by the user to main body 11. The magnitude of the force applied to main body 11 by movable unit 101 may be the same as or smaller than the force applied by the user. The force applied to main body 11 by movable unit 101 may be, for example, a resistance force generated by a spring, a damper, or the like. Alternatively, movable unit 101 may cause main body 11 to move irrelevant to the force applied by the user. When movable unit 101 performs such an operation, the user can recognize that the operation on main body 11 is not accepted.

When receiving synchronization information from another communication device via communicator 102 to be described later, movable unit 101 causes the main body 11 to take the posture indicated by the synchronization information. Thereafter, movable unit 101 maintains the posture of the main body 11 until accepting a user's operation or until receiving new synchronization information from another communication device.

Communicator 102 is a communication device for communicating with the outside. Communicator 102 can perform, for example, wireless communication such as Wi-Fi (registered trademark) or wired communication using a LAN cable or the like. Communicator 102 can communicate with another communication device having a configuration similar to that of communication device 10, for example. Furthermore, communicator 102 may be capable of communicating with relay device 20 described in a modification to be described later.

Controller 103 controls each component of communication device 10. The operation of communication device 10 to be described later is implemented by controller 103 integrally controlling each component of communication device 10.

When the user performs an operation on main body 11, controller 103 generates synchronization information indicating the content of the operation and transmits the synchronization information to another communication device via communicator 102. When receiving the synchronization information, another communication device can operate its own movable unit in accordance with the content of the operation indicated by the synchronization information, and move the main body. As a result, it is possible to synchronize the posture taken by the main body as a result of the operation performed on the main body by the user in one communication device with the main body of the other communication device. Note that the synchronization information is periodically generated, and is transmitted to the other communication device as needed, for example, while the user is performing an operation. Alternatively, for example, the synchronization information indicating the final posture of main body 11 may be generated only once after the user's operation is completed.

### Configuration of communication device system 100

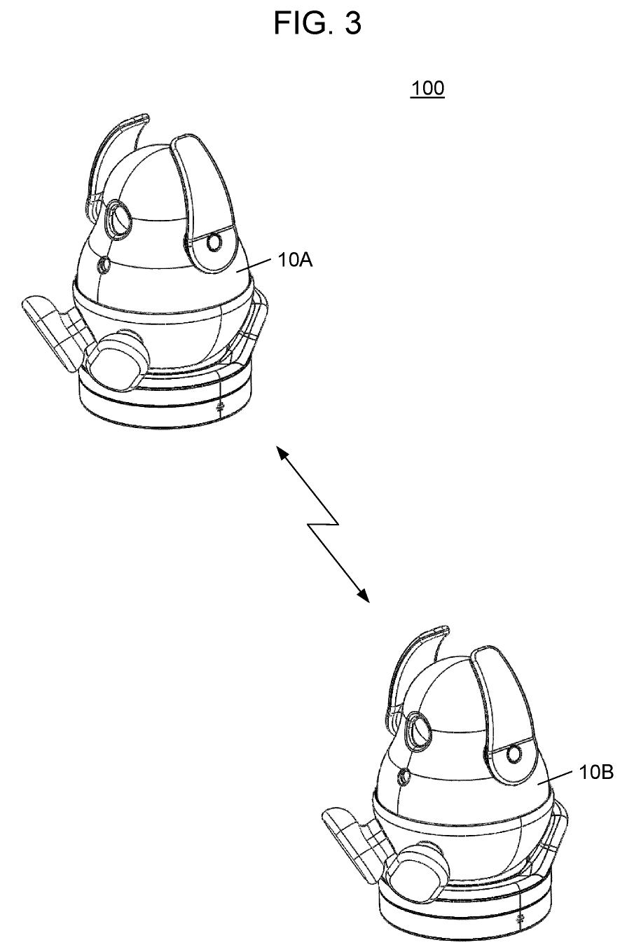

FIG. 3 is a schematic diagram of communication device system 100 according to the exemplary embodiment of the present disclosure. As illustrated in FIG. 3, communication device system 100 includes a plurality of communication devices 10. In the example shown in FIG. 3, communication device system 100 includes two communication devices 10, but the communication devices of the present disclosure may include three or more communication devices.

In the following exemplary embodiment, a case in which communication device system 100 includes two communication devices 10 as illustrated in FIG. 3 will be described.

In the following description, when it is necessary to distinguish two communication devices included in communication device system 100, one may be referred to as first communication device 10A and the other may be referred to as second communication device 10B.

First communication device 10A and second communication device 10B may communicate with each other via a public network (not illustrated in FIG. 3) such as the Internet, or may directly communicate with each other without going through another network.

### Operation example of communication device 10

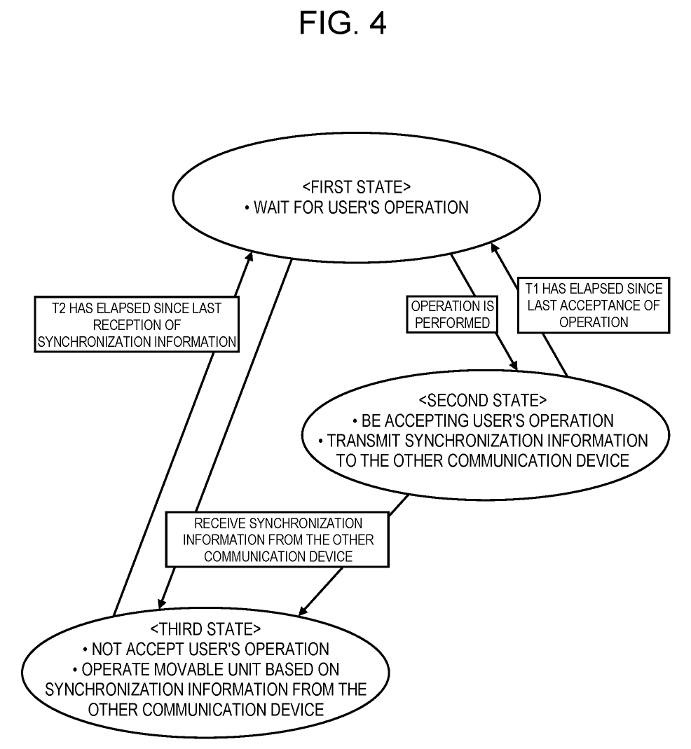

Hereinafter, an operation example of communication device 10 included in communication device system 100 will be described. Communication device 10 shifts to one of multiple operation states according to various conditions. FIG. 4 is a state transition diagram for describing operation states of communication device 10.

In the example illustrated in FIG. 4, communication device 10 can transition to any of a first state, a second state, and a third state.

The first state is a state of waiting for user's operation. The first state is a state in which the user's operation can be accepted and the user's operation has not been performed yet.

When a user’s operation is performed in the first state, communication device 10 shifts to the second state. The second state is a state in which an operation by the user is being accepted and synchronization information indicating the content of the operation being accepted is generated as needed to be transmitted to the other communication device. This makes it possible to cause the posture taken by the main body as a result of the user's operation performed on one communication device to be taken by the main body of the other device as well.

Note that communication device 10 shifts to the first state when first time period T1 has elapsed since the last acceptance of the user's operation on main body 11 in the second state. First time period T1 is a preset time period, and is, for example, 0.1 seconds to 1 second.

Furthermore, when synchronization information from the other communication device is received in the first state or the second state, communication device 10 shifts to the third state. The third state is a state in which movable unit 101 is operated so that main body 11 takes a posture indicated by synchronization information from the other communication device. In the third state, even if the user performs an operation on main body 11, communication device 10 does not accept the operation.

As described above, in the third state, communication device 10 gives priority to causing main body 11 to take a posture in accordance with synchronization information from the other communication device rather than the user's operation on the own communication device. Hereinafter, the other communication device may be referred to as the other device, and the own communication device may be referred to as an own device. This makes it possible to clarify the priority order in a case in which the user's operation on the own device and the reception of the synchronization information from the other device are almost simultaneous, and therefore making it possible to smoothly perform communication via a plurality of communication devices.

In order to make the user recognize that the operation cannot be accepted when the user's operation is performed on the own device in the third state, as described above, movable unit 101 may apply the force in the direction opposite to the force applied by the user's operation to main body 11. Furthermore, movable unit 101 may move main body 11 to take a posture according to the synchronization information received from the other device while ignoring the user's operation.

In the third state, when second time period T2 has elapsed since the last reception of synchronization information from the other device, communication device 10 shifts to the first state. Second time period T2 is a preset time period, for example, 1 second to 5 seconds. Second time period T2 may be the same as or different from first time period T1. In other words, communication device 10 maintains the third state for second time period T2 after receiving the synchronization information from the other device. Note that second time period T2 is an example of a predetermined time in the present disclosure.

That is, communication device 10 returns to the first state (the state of waiting for the user's operation) in a case in which there is no user's operation on the own device or reception of synchronization information from the other device for a predetermined time. That is, it can be said that the first state is a basic state of communication device 10. The posture of main body 11 after returning from the second state to the first state is maintained in the posture finally taken by main body 11 by the user's operation. Furthermore, the posture of main body 11 after returning from the third state to the first state is maintained in the posture indicated by the synchronization information from the other communication device.

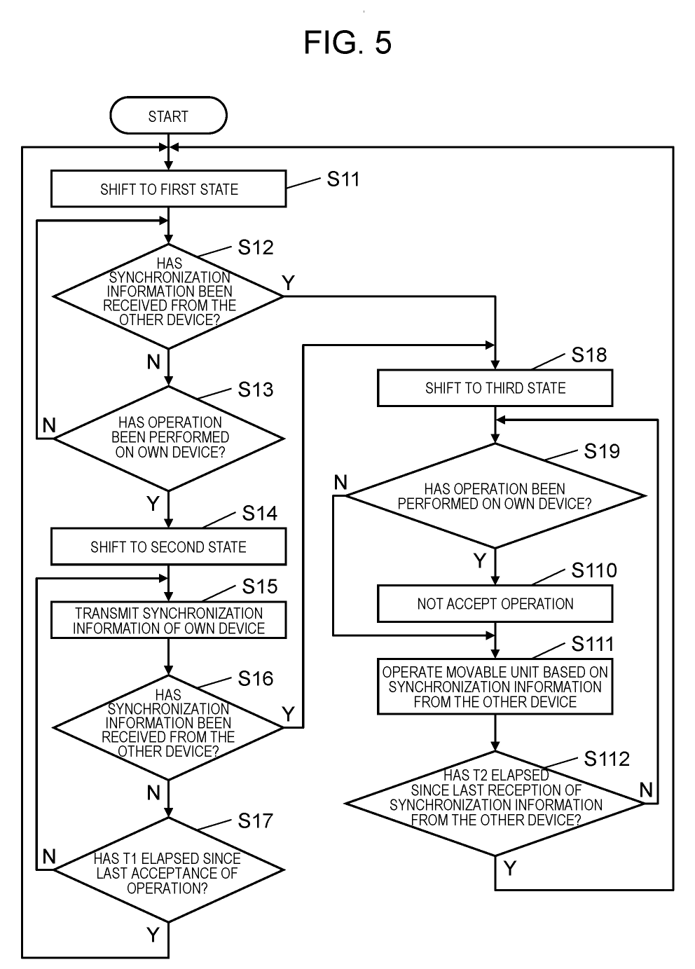

FIG. 5 is a flowchart for describing an operation example of communication device 10.

First, in step S11, communication device 10 shifts to the first state.

In step S12, communication device 10 determines whether synchronization information from the other device has been received. If it is determined that the reception information from the other device has not been received (step S12: N), communication device 10 advances the processing to step S13. If it is determined that the reception information from the other device has been received (step S12: Y), communication device 10 advances the processing to step S18.

In step S13, communication device 10 determines whether a user’s operation has been performed on main body 11 of the own device. If it is determined that the user’s operation has been performed (step S13: Y), communication device 10 advances the processing to step S14. If it is determined that the user's operation has not been performed (step S13: N), communication device 10 returns the processing to step S12.

In step S14, communication device 10 shifts to the second state in response to an operation on main body 11 of the own device.

In step S15, communication device 10 transmits synchronization information of the own device generated by movable unit 101 based on a user’s operation on main body 11 of the own device to the other device via communicator 102.

In step S16, communication device 10 determines whether synchronization information from the other device has been received. If it is determined that the reception information from the other device has not been received (step S16: N), communication device 10 advances the processing to step S17. If it is determined that the reception information from the other device has been received (step S16: Y), communication device 10 advances the processing to step S18.

Note that steps S12 and S16 are processes having the same contents, but are different in that step S12 is a process in the first state, whereas step S16 is a process in the second state.

In step S17, communication device 10 determines whether first time period T1 has elapsed since the last acceptance of the user's operation. If it is determined that first time period T1 has elapsed since the last acceptance of the user's operation (step S17: Y), communication device 10 returns the processing to step S11 and shifts to the first state. As described above, the posture of main body 11 of the own device after the shift from the second state to the first state is maintained in the posture finally taken by the user's operation. If it is determined that first time period T1 has not elapsed since the last acceptance of the user's operation (step S17: N), communication device 10 returns the processing to step S15.

If synchronization information from the other device is received in the first state or the second state, communication device 10 shifts to the third state in step S18.

In step S19, communication device 10 determines whether a user’s operation has been performed on main body 11 of the own device. If it is determined that the user’s operation has been performed (step S19: Y), communication device 10 advances the processing to step S110. If it is determined that the user's operation has not been performed (step S19: N), communication device 10 advances the processing to step S111.

Note that steps S13 and S19 are processes having the same contents, but are different in that step S13 is a process in the first state, whereas step S19 is a process in the third state.

In step S110, communication device 10 does not accept the user's operation.

In step S111, communication device 10 operates movable unit 101 based on the synchronization information received from the other device. This can cause main body 11 of the own device to take the same posture as the main body of the other device that has transmitted the synchronization information.

In step S112, communication device 10 determines whether second time period T2 has elapsed since the last reception of synchronization information from the other device. If it is determined that second time period T2 has not elapsed since the last reception of synchronization information from the other device (step S112: N), communication device 10 returns the processing to step S19. If it is determined that second time period T2 has elapsed since the last reception of synchronization information from the other device (step S112: Y), communication device 10 returns the processing to step S11 and shifts to the first state. The posture of main body 11 of the own device after the shift from the third state to the first state is maintained as the posture indicated by the synchronization signal from the other device as described above.

As described above, when an operation is performed on the own device in the first state, communication device 10 shifts to the second state, generates synchronization information based on the operation, and transmits the synchronization information to the other device. The other device operates the movable unit of the other device so that the main body of the other device takes the posture indicated by the synchronization information based on the synchronization information received from the own device. This can cause the main body of the other device to take the same posture as the posture finally taken by main body 11 of the own device due to the user's operation of the own device. Therefore, it is possible to suitably communicate from the user of the own device to the user of the other device.

Furthermore, when communication device 10 receives synchronization information from the other device in the first state or the second state, it shifts to the third state. In the third state, unlike the first state or the second state, the user's operation on main body 11 of the own device is not accepted, and movable unit 101 is operated to cause main body 11 to take the posture indicated by the synchronization information based on the synchronization information received from the other device. As a result, the posture that the user of the other device has caused the main body of the other device to take is reflected on main body 11 of the own device. This makes it possible to suitably communicate from the user of the other device to the user of the own device. Furthermore, since a user’s operation on main body 11 of the own device is not accepted for a while after the synchronization information is received from the other device, the posture of main body 11 of the own device can be reliably synchronized with the posture of the main body of the other device.

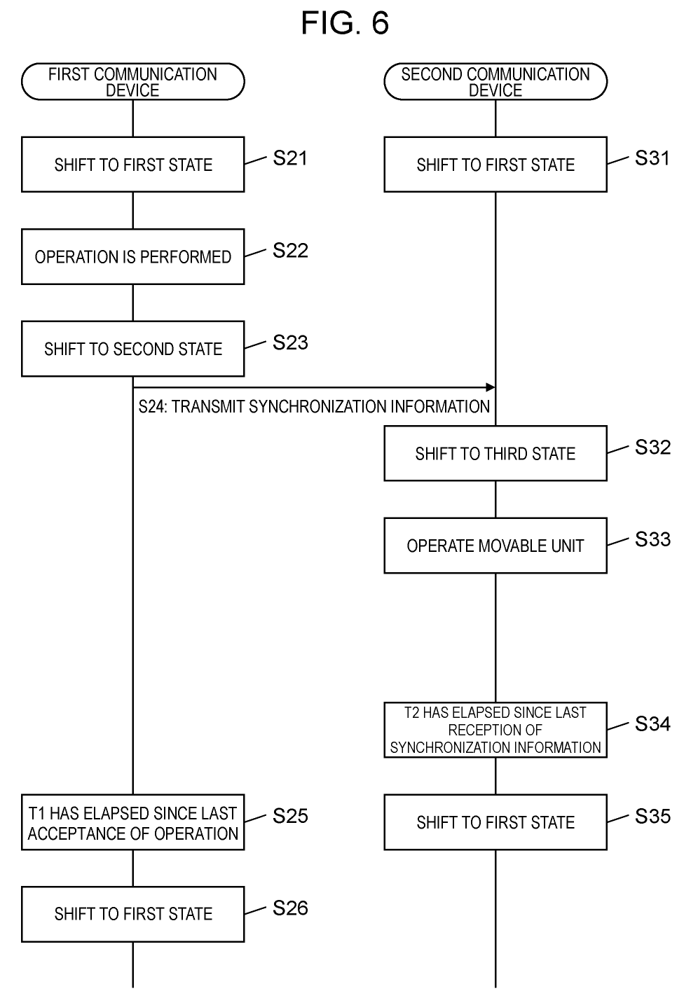

FIG. 6 is a sequence diagram for describing a first operation example in communication device system 100. FIG. 6 illustrates how first communication device 10A and second communication device 10B cooperate with each other.

In step S21, first communication device 10A shifts to the first state. In step S31, first communication device 10A shifts to the first state. Note that steps S21 and S31 do not need to be performed simultaneously, and timings at which the communication devices shift to the first state may be different from each other.

It is assumed that when both first communication device 10A and second communication device 10B are each in the first state of waiting for a user's operation as described above, the user's operation is performed in first communication device 10A (step S22).

In step S23, first communication device 10A shifts to the second state in response to a user's operation. Accordingly, in step S24, first communication device 10A transmits the synchronization information by the user's operation to second communication device 10B.

Second communication device 10B shifts to the third state in step S32 in response to reception of the synchronization information from first communication device 10A.

In step S33, second communication device 10B operates movable unit 101 based on the synchronization information, and moves main body 11 to take the posture indicated by the synchronization information. This synchronizes the posture of main body 11 of first communication device 10A with the posture of main body 11 of second communication device 10B.

Thereafter, it is assumed that second time period T2 has elapsed since the last reception of synchronization information from first communication device 10A in the second communication device 10B (step S34). In response to this, second communication device 10B shifts to the first state (step S35). This allows second communication device 10B to accept the user's operation.

On the other hand, it is assumed that first time period T1 has elapsed since the last acceptance of the user's operation in the first communication device 10A (step S25). In response to this, first communication device 10A shifts to the first state (step S26). Note that, in the example illustrated in FIG. 5, it is illustrated that step S25 of first communication device 10A is performed later than step S34 of second communication device 10B, but the present invention is not limited thereto in practice.

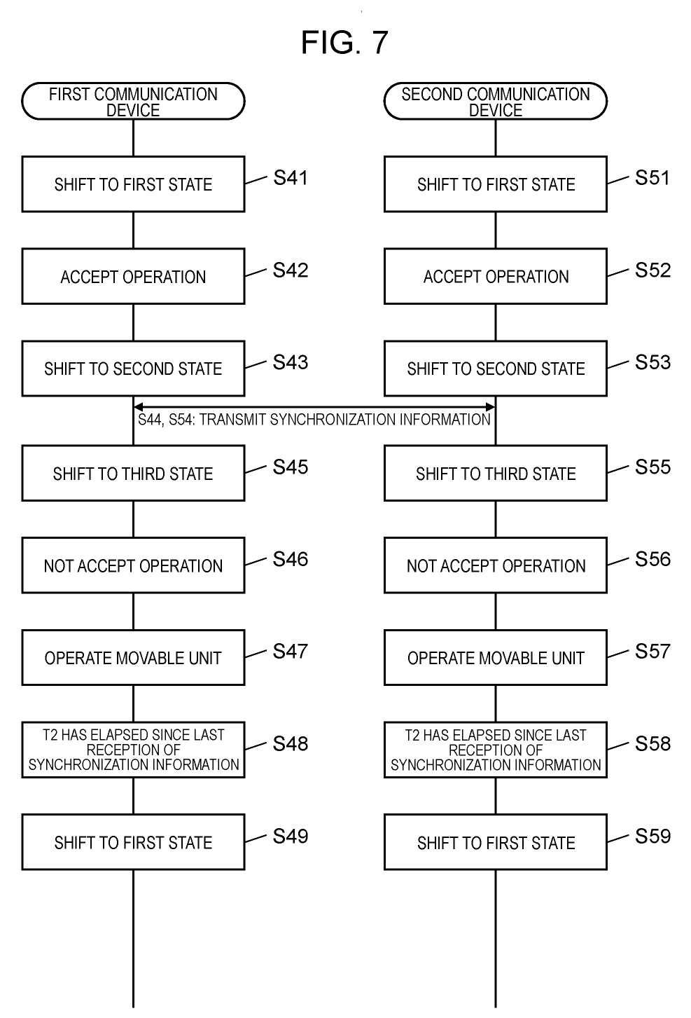

In the first operation example illustrated in FIG. 6, no user’s operation is performed on second communication device 10B. In FIG. 7, a second operation example will be described in which the users’ operations are performed on both first communication device 10A and second communication device 10B almost simultaneously.

FIG. 7 is a sequence diagram for describing the second operation example in communication device system 100.

In step S41, first communication device 10A shifts to the first state. In step S51, first communication device 10A shifts to the first state. Note that steps S41 and S51 do not need to be performed simultaneously, and timings at which communication devices shift to the first states may be different from each other.

It is assumed that when both first communication device 10A and second communication device 10B are each in the first state of waiting for a user's operation as described above, users' operations are performed almost simultaneously in first communication device 10A and second communication device 10B (step S42, step S52).

In this case, both first communication device 10A and second communication device 10B shift to the second state (step S43, step S53), and each transmits the synchronization information to the other (step S44, step S54).

In step S45, first communication device 10A having received the synchronization information from second communication device 10B shifts to the third state. Similarly, in step S55, second communication device 10B having received the synchronization information from first communication device 10A shifts to the third state. As a result, while in the third states, neither first communication device 10A nor second communication device 10B accepts the user's operation (step S46, step S56).

In step S47, first communication device 10A tries to operate movable unit 101 based on the synchronization information from second communication device 10B. Similarly, in step S57, second communication device 10B tries to operate movable unit 101 based on the synchronization information from first communication device 10A. However, in the operation example illustrated in FIG. 7, since each of first communication device 10A and second communication device 10B receives the synchronization information from the other communication device immediately after shifting from the first state to the second state and shifts to the third state, the posture of each main body 11 is substantially unchanged from the initial state. Therefore, in steps S47 and S57, first communication device 10A and second communication device 10B each maintain the third state while substantially not moving movable unit 101. As a result, each of first communication device 10A and second communication device 10B goes into a state in which each cannot accept the user's operation.

As described above, in communication device 10, even if the user tries to perform an operation in the third state, movable unit 101 applies a force in a direction opposite to the force applied by the user's operation to main body 11, for example, to cause the user to recognize that the operation is not accepted. Therefore, after steps S47 and S57, each user refrains from the operation.

If second time period T2 has elapsed since reception of synchronization information from second communication device 10B (step S48), first communication device 10A shifts to the first state (step S49). Similarly, if second time period T2 has elapsed since reception of synchronization information from first communication device 10A (step S58), second communication device 10B shifts to the first state (step S59). This allows each of first communication device 10A and second communication device 10B to return to a state of waiting for the user's operation and to accept the user's operation again.

Note that in the example shown in FIG. 7, first communication device 10A and second communication device 10B shift to the first state at substantially the same timing in steps S49 and S59. In this case, if both users return to the first state and start the operation simultaneously, each process of the operation example illustrated in FIG. 7 is performed again from the beginning. In this case, it is difficult to achieve suitable communication between the two, and thus, for example, second time periods T2 for shifting from the third states to the first states may be made different between first communication device 10A and second communication device 10B.

### Actions and effects

As described above, communication device system 100 according to the exemplary embodiment of the present disclosure includes multiple communication devices 10, and each communication device 10 includes: movable unit 101 that can switch whether to accept an operation; communicator 102 that transmits synchronization information indicating a posture of movable unit 101 changed based on the operation accepted by movable unit 101 to another communication device and receives the synchronization information from the other communication device; and control unit 103 that shifts communication device 10 from a state in which the operation on movable unit 101 can be accepted to a state in which the operation on movable unit 101 is not accepted when the synchronization information is received from the other communication device.

Furthermore, according to communication device system 100 according to the exemplary embodiment of the present disclosure, control unit 103 shifts communication device 10 to any of multiple states including: a first state of waiting for a start of the operation; a second state in which movable unit 101 is accepting the operation and communicator 102 transmits the synchronization information based on the operation being accepted to the other communication device; and a third state that is a state to which a shift is made when the synchronization information from the other communication device is received in the first state or the second state, the third state being a state in which the operation is not accepted.

With such a configuration, when synchronization information is received from another communication device (another device) among the multiple communication devices 10 included in communication device system 100, operation on the own device is not accepted, and movable unit 101 is operated based on the synchronization information of the other device, whereby the posture of main body 11 of the own device can be reliably set to the same posture as that of the main body of the other device. This makes it possible to achieve reliable communication between the multiple communication devices 10. This allows the user of each communication device 10 to be given high satisfaction.

### Modification

Hereinafter, modifications of the above-described exemplary embodiment will be described. Also in the description of the modifications, the configurations similar to those of the above-described exemplary embodiment will be described with the same reference numerals and characters as those of the above-described exemplary embodiment.

### First modification

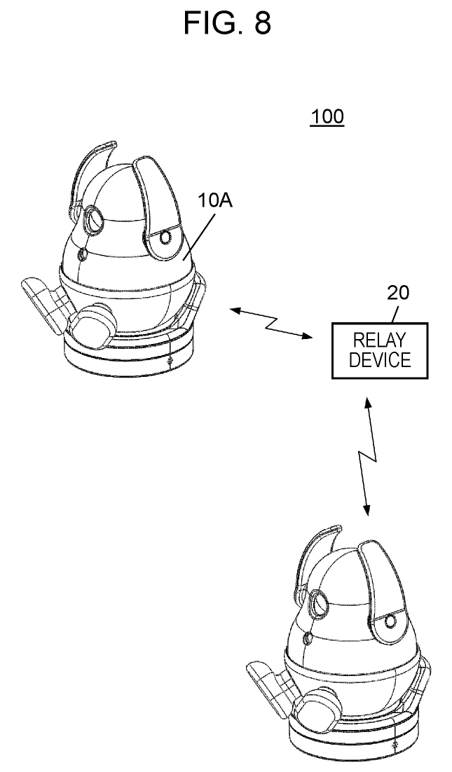

In a first modification, a case will be described in which communication device system 100 includes relay device 20 that relays communication between multiple communication devices 10 in addition to the multiple communication devices 10. FIG. 8 is a schematic diagram illustrating a first modification of communication device system 100.

Relay device 20 is, for example, a computer such as a personal computer (PC) or a tablet terminal. Relay device 20 receives synchronization information transmitted from first communication device 10A and addressed to second communication device 10B, and transmits the synchronization information to second communication device 10B. Similarly, relay device 20 receives synchronization information transmitted from second communication device 10B and addressed to first communication device 10A, and transmits the synchronization information to first communication device 10A.

For example, when relay device 20 receives the synchronization information almost simultaneously from each of first communication device 10A and second communication device 10B, relay device 20 transmits the synchronization information received even slightly earlier to the other communication device and discards the synchronization information received even slightly later. As a specific example, when the synchronization information from first communication device 10A is received several seconds earlier than the synchronization information from second communication device 10B, the synchronization information from first communication device 10A is transmitted to second communication device 10B, and the synchronization information from second communication device 10B is discarded. This makes it possible to prevent a situation in which both communication devices 10 shift to the third states and therefore both communication devices 10 each cannot accept the user's operation for a while as in the second operation example described with reference to FIG. 7.

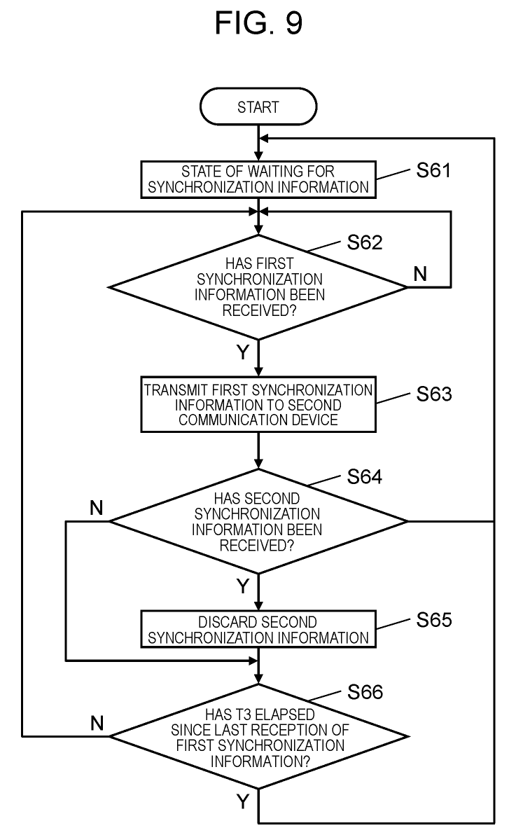

FIG. 9 is a flowchart for describing an operation example of the relay device.

In step S61, relay device 20 is in a state of waiting for synchronization information from the multiple communication devices 10.

In step S62, relay device 20 determines whether a first synchronization information from first communication device 10A has been received. If it is determined that the first synchronization information from first communication device 10A has been received (step S62: Y), relay device 20 advances the processing to step S63, and otherwise (step S62: N), it repeats the process of step S62.

In step S63, relay device 20 transmits the first synchronization information received from first communication device 10A to second communication device 10B.

In step S64, relay device 20 determines whether the second synchronization information has been newly received. If the second synchronization information has not been newly received (step S64: N), relay device 20 advances the processing to step S66. If the second synchronization information has been newly received (step S64: Y), relay device 20 advances the processing to step S65.

In step S65, relay device 20 discards the newly received second synchronization information. This makes it possible to prevent a situation in which: first communication device 10A shifts to the third state due to first communication device 10A receiving the second synchronization information from second communication device 10B even though the user's operation is being performed in first communication device 10A; and the user's operation in first communication device 10A is interrupted.

In step S66, relay device 20 determines whether third time period T3 has elapsed since the last reception of the first synchronization information. If it is determined that third time period T3 has elapsed since the last reception of the first synchronization information (step S66: Y), relay device 20 returns the processing to step S61. As a result, relay device 20 can receive new synchronization information. If it is determined that third time period T3 has not elapsed since the last reception of the first synchronization information (step S66: N), relay device 20 returns the processing to step S62.

Note that third time period T3 is a preset time, for example, 1 second to 5 seconds. Third time period T3 may be the same as or different from first time period T1 and second time period T2 in communication device 10 of the above-described exemplary embodiment.

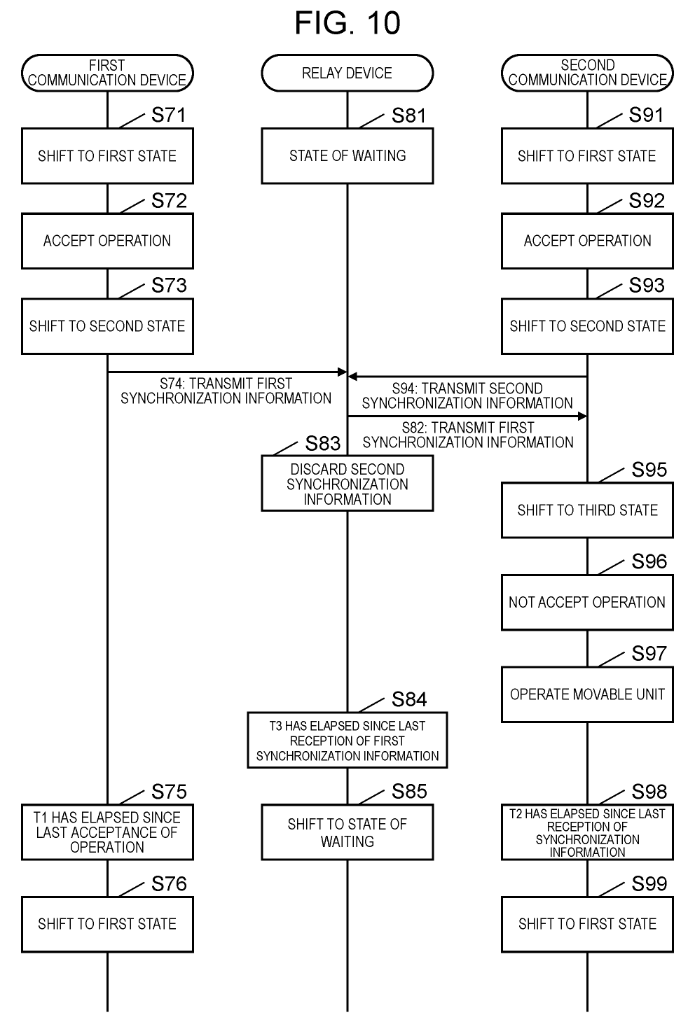

FIG. 10 is a sequence diagram for describing an operation example in the first modification.

In step S71, first communication device 10A shifts to the first state. In step S91, first communication device 10A shifts to the first state. Furthermore, in step S81, relay device 20 shifts to the state of waiting for a synchronization signal. Note that steps S71, S81, and S91 do not need to be performed simultaneously, and may be performed at different timings.

It is assumed that when both first communication device 10A and second communication device 10B are in the first state of waiting for user's operation and relay device 20 is in the state of waiting for synchronization information from communication device 10, a user's operation is performed almost simultaneously in each of first communication device 10A and second communication device 10B (step S72, step S92).

In this case, both first communication device 10A and second communication device 10B shift to the second state (step S73, step S93), and each transmits synchronization information to relay device 20 (step S74, step S94). Note that, in the example illustrated in FIG. 10, it is assumed that the transmission of the first synchronization information from first communication device 10A is performed slightly earlier than the transmission of the second synchronization information from second communication device 10B.

In this case, as described with reference to FIG. 9, relay device 20 preferentially handles first communication device 10A that has transmitted the first synchronization information earlier. Therefore, in step S82, relay device 20 transmits the first synchronization information to second communication device 10B.

On the other hand, in step S83, relay device 20 discards the second synchronization information received from second communication device 10B. This causes the second synchronization information not to be transmitted to first communication device 10A, and makes it possible to prevent a situation in which first communication device 10A shifts to the third state before the user's operation is completed.

Second communication device 10B having received the first synchronization information shifts to the third state in step S95. Due to this, while being in the third state, second communication device 10B does not accept any user's operation (step S96). In step S97, second communication device 10B operates movable unit 101 based on the first synchronization information, and synchronizes the posture of main body 11 in second communication device 10B with the same posture as that of main body 11 of first communication device 10A. This reliably causes communication from the user of first communication device 10A to the user of second communication device 10B.

Thereafter, when third time period T3 has elapsed since the last reception of the first synchronization information (step S84), relay device 20 returns to the state of waiting for a synchronization signal (step S85). This makes a state in which the synchronization signal from communication device 10 can be received again.

When first time period T1 has elapsed since the last acceptance of the user's operation (step S75), first communication device 10A shifts to the first state (step S76). Similarly, when second time period T2 has elapsed since reception of the first synchronization information (step S98), second communication device 10B shifts to the first state (step S99). This allows each of first communication device 10A and second communication device 10B to return to a state of waiting for the user's operation and to accept the user's operation again.

As described above, in the first modification, when relay device 20 receives synchronization information from multiple communication devices 10 almost simultaneously, synchronization information received first is preferentially handled, and synchronization information received later is discarded. This makes it possible to prevent a situation in which all of the multiple communication devices 10 shift to the third state even though the operations of the users have not been completed and the operations of the users cannot be accepted any more.

### Second modification

In a second modification, communication device 10 can shift to a fourth state in addition to the first state, the second state, and the third state described in the above-described exemplary embodiment.

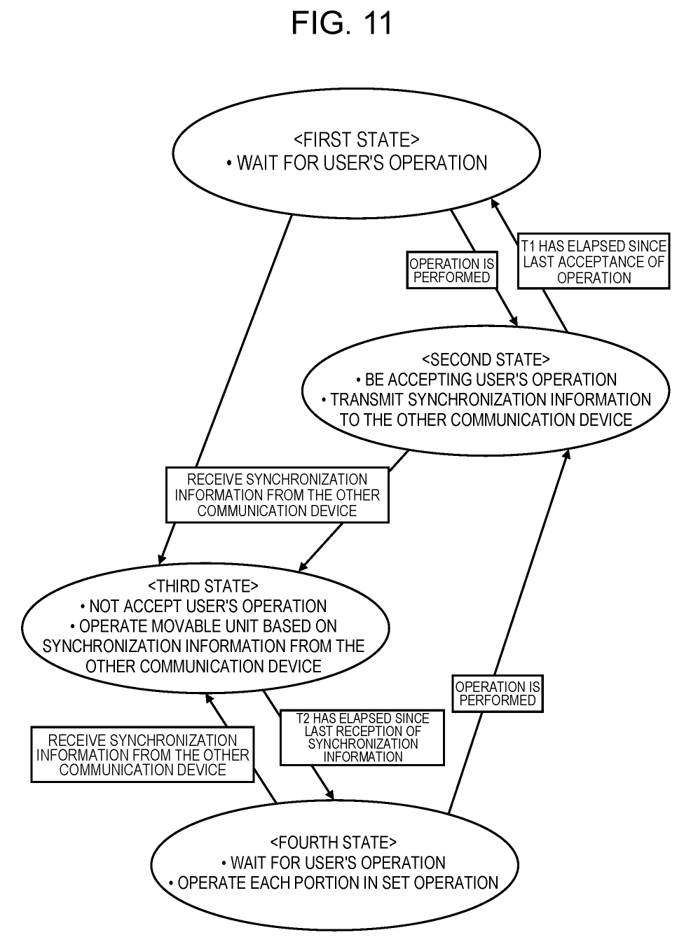

FIG. 11 is a state transition diagram of the second modification of the communication device including the first state, the second state, the third state, and the fourth state. Since the first state, the second state, and the third state are similar to those of the above-described exemplary embodiment, the description thereof will be omitted.

In the above-described exemplary embodiment, when second time period T2 has elapsed in the third state since the last reception of the synchronization information from the other communication device, communication device 10 shifts to the first state. However, in the second modification, communication device 10 shifts to the fourth state instead of the first state.

The fourth state is a state of waiting for an operation on movable unit 101 as in the first state, but is different from the first state in that each portion of communication device 10 performs a preset operation.

The operation of each portion of the communication device in the fourth state is, for example, as follows (see FIG. 1).

Main body 11 swings (for example, front-rear or left-right reciprocating motion).

Arms 13 move (for example, front-rear reciprocating motion).

Legs 14 move (for example, up-down or left-right reciprocating motion).

Eye 15 shines (for example, lighting, blinking, changing in color, and the like).

Camera 16 recognizes the position of the user, and the front surface of main body 11 faces the user.

LED 17 shines (for example, lighting, blinking, changing in color, changing in bright region).

Speaker 19 emits a sound (for example, a message or music).

Heater 110 operates (for example, the periphery of heater 110 is warmed up.)

The operation of each portion of the communication device in the fourth state may be any one of these operations, or may be a combination of a plurality of the operations.

As described above, a shift to the fourth state is made after the third state. That is, the fourth state is a state in which main body 11 of the own device is synchronized with the posture of the main body of the other device based on the synchronization information from the other device, and then an operation of the user of the own device is awaited. In the fourth state, by the portions of communication device 10 performing these operations, it is possible to prompt the user of the own device to respond to communication from the user of the other device. This allows for smooth communication performed between the user of the own device and the user of the other device.

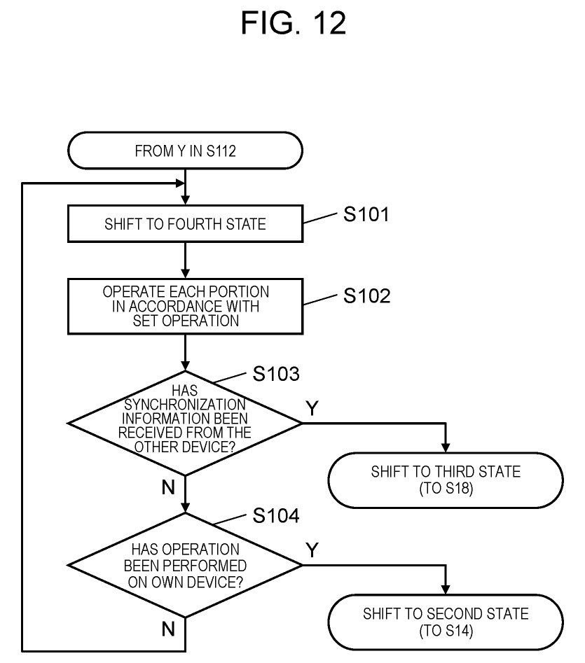

FIG. 12 is a flowchart for describing an operation example regarding the fourth state of communication device 10 in the second modification.

As described above, communication device 10 shifts to the fourth state when second time period T2 has elapsed since the last reception of synchronization information from the other device in the third state. That is, shift to the flowchart of the fourth state illustrated in FIG. 12 is made when step S112 is Y in the operation example of the exemplary embodiment of the present disclosure illustrated in FIG. 5.

In step S101, communication device 10 shifts to the fourth state.

In step S102, communication device 10 causes each portion to perform a preset operation.

In step S103, communication device 10 determines whether synchronization information has been received from the other device in the fourth state. If synchronization information is received from the other device in the fourth state (step S103: Y), communication device 10 shifts to the third state. That is, the processing returns to step S18 of the operation example of FIG. 5. If synchronization information has not been received from the other device in the fourth state (step S103: N), communication device 10 advances the processing to step S104.

In step S104, communication device 10 determines whether a user’s operation has been performed on the own device in the fourth state. If a user’s operation is performed on the own device in the fourth state (step S104: Y), communication device 10 shifts to the second state. That is, the processing returns to step S14 of the operation example of FIG. 5. If the synchronization information has not been received from the other device in the fourth state (step S104: N), communication device 10 returns the processing to step S101 and continues the fourth state.

With such a configuration, after the third state ends, communication device 10 can prompt the user of the own device to respond to the user of the other device.

### Third modification

In a third modification, an operation will be described in a case in which any of communication devices 10 included in communication device system 100 is newly powered on.

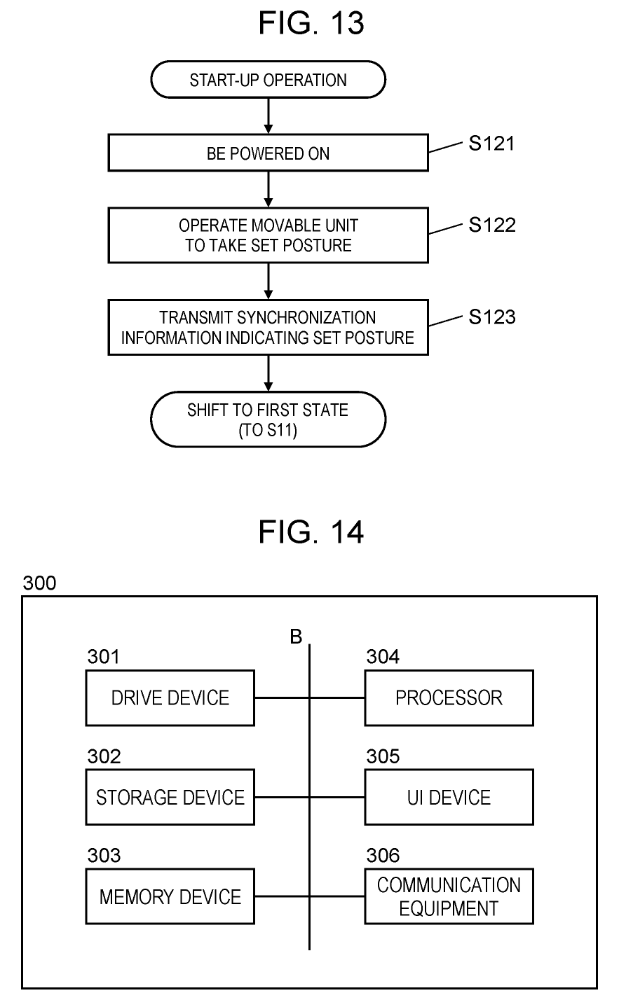

FIG. 13 is a flowchart for describing a start-up operation when communication device 10 is started up by being powered on.

In step S121, communication device 10 is powered on (turned on).

In step S122, communication device 10 having been started up operates movable unit 101 to take a preset posture. The preset posture is the most basic posture (initial posture) of communication device 10, and is, for example, a posture in which main body 11 is not rotated along any axis, that is, a posture in which main body 11 is upright.

In step S123, communication device 10 transmits synchronization information indicating the initial posture to the other device. Thereafter, communication device 10 shifts to the first state. That is, the processing returns to step S11 of the operation example of FIG. 5.

With such an operation, communication device 10 that has been newly powered on can synchronize with the other device without any problem.

### Example of hardware configuration of computer

In the exemplary embodiment and the modifications of the present disclosure, it has been described that communication devices 10 and relay device 20 are computers or each include a computer.

FIG. 14 is a block diagram illustrating an example of a hardware configuration of a computer that implements communication device 10 or relay device 20.

Computer 300 includes drive device 301, storage device 302, memory device 303, processor 304, user interface (UI) device 305, and communication equipment 306 that are interconnected via bus B. Controller 103 may include storage device 302, memory device 303, and processor 304.

A program for implementing various functions and processes of communication device 10 or relay device 20 is stored in a detachable storage medium such as a compact disk-read only memory (CD-ROM) or a flash memory. When the storage medium is set in the drive device 301, a program is installed from the storage medium to storage device 302 or memory device 303 via the drive device 301. However, the program is not necessarily installed from the storage medium, and may be downloaded from an external device to computer 300 via a network or the like and installed.

Storage device 302 is implemented by a storage device such as a hard disk drive (HDD) or an SSD, and stores a file, data, and the like to be used to execute a program together with the installed program.

Memory device 303 is implemented by a random access memory, a static memory, or the like, and reads a program, data, or the like from storage device 302 and stores the program, the data, or the like when the program is activated. Storage device 302, memory device 303, and the detachable storage medium may be collectively referred to as non-transitory storage media.

Processor 304 may be implemented by one or more CPUs, graphics processing units (GPUs), processing circuitry, and the like that can be configured with one or more processor cores, and executes various functions and processes of communication devices 10 or relay device 20 in accordance with the program stored in memory device 303, data such as parameters necessary for executing the program, and the like.

User interface (UI) device 305 is, for example, another configuration of main body 11 and communication device 10 illustrated in FIG. 1. Alternatively, UI device 305 may include an input device such as a keyboard, a mouse, a camera, and a microphone, an output device such as a display, a speaker, a headset, and a printer, and an input/output device such as a touch panel. In this case, for example, the user may operate a graphical user interface (GUI) displayed on a display or a touch panel with a keyboard, a mouse, or the like, to operate communication device 10 or relay device 20.

The communication equipment 306 is a hardware configuration that implements a function of communicator 102 of communication device 10, for example, and is implemented by various communication circuits that execute wired or wireless communication processing with a communication network such as an external device, the Internet, a local area network (LAN), or a cellular network.

### INDUSTRIAL APPLICABILITY

The communication device system of the present disclosure is useful in systems that include communication devices that facilitate communication between multiple users.

### REFERENCE MARKS IN THE DRAWINGS

100 communication device system

10 communication device

10A first communication device

10B second communication device

11 main body

12 base

13 arm

14 leg

15 eye

16 camera

17 LED

18 microphone

19 speaker

110 heater

101 movable unit

102 communicator

103 controller

20 relay device

300 computer

301 drive device

302 storage device

303 memory device

304 processor

305 UI device

306 communication equipment

1. A communication device system comprising multiple communication devices, wherein
each communication device includes:
a movable unit that switches whether to accept an operation;
a communicator that transmits synchronization information indicating a posture of the movable unit changed based on the operation accepted by the movable unit to another communication device among the multiple communication devices and receives the synchronization information from the other communication device; and
a control unit that shifts the communication device from a state in which the operation on the movable unit is accepted to a state in which the operation on the movable unit is not accepted for a predetermined time after the synchronization information is received from the other communication device.

2. The communication device system according to claim 1, wherein
the control unit shifts the communication device to any of multiple states including:
a first state of waiting for a start of the operation;
a second state in which the movable unit is accepting the operation and the communicator transmits the synchronization information based on the operation being accepted to the other communication device; and
a third state that is a state to which a shift is made when the synchronization information from the other communication device is received in the first state or the second state, the third state being a state in which the operation is not accepted.

3. The communication device system according to claim 2, wherein
the control unit causes the movable unit to operate based on the synchronization information received from the other communication device in the third state.

4. The communication device system according to claim 2, wherein
the control unit shifts the communication device to the second state when newly accepting the operation in the first state.

5. The communication device system according to claim 2, wherein
the control unit shifts the communication device to the first state after a first time period has elapsed since a last acceptance of the operation in the second state.

6. The communication device system according to claim 2, wherein
the control unit shifts the communication device to the first state after a second time period has elapsed since a last reception of the synchronization information from the other of the communication device in the third state.

7. The communication device system according to claim 1,
further comprising a relay device that relays communication between the multiple communication devices, wherein
when the relay device receives first synchronization information transmitted from a first communication device among the multiple communication devices to a second communication device among the multiple communication devices and subsequently receives second synchronization information transmitted from the second communication device to the first communication device, the relay device transmits the first synchronization information to the second communication device and does not transmit the second synchronization information to the first communication device until a third time period elapses after a last reception of the first synchronization information.

8. The communication device system according to claim 2, wherein
the control unit shifts the communication device to a fourth state in which the movable unit performs a preset autonomous operation, after a second time period has elapsed since a last reception of the synchronization information from the other of the communication device in the third state.

9. The communication device system according to claim 2, wherein
the control unit shifts the communication device to a fifth state in which, when the communication device is powered on, the movable unit operates to take a preset posture, and the communicator transmits synchronization information indicating the preset posture to the other communication device.

10. A communication device that communicates with another communication device, the communication device comprising:
a movable unit that switches whether to accept an operation;
a communicator that transmits synchronization information for synchronizing a posture of the movable unit based on the operation accepted by the movable unit to the other communication device and receives the synchronization information from the other communication device; and
a control unit that shifts the communication device from a state in which the operation on the movable unit is accepted to a state in which the operation on the movable unit is not accepted for a predetermined time after the synchronization information is received from the other communication device.

11. A communication device control method executed by a computer included in a communication device that communicates with another communication device, the method comprising:
accepting an operation in a state in which the operation on a movable unit included in the communication device is accepted;
transmitting synchronization information indicating a posture of the movable unit changed based on the operation to the other communication device;
receiving the synchronization information from the other communication device in a state in which an operation on the movable unit included in the communication device is accepted; and
shifting the communication device from a state in which the operation on the movable unit is accepted to a state in which the operation on the movable unit is not accepted for a predetermined time after the synchronization information is received from the other communication device.

12. A program executed by a computer included in a communication device that communicates with another communication device, the program comprising causing the computer to execute:
a procedure of transmitting synchronization information to the other communication device when an operation is accepted in a state in which the operation on a movable unit included in the communication device is accepted, the synchronization information indicating a posture of the movable unit changed based on the operation; and
a procedure of shifting the communication device from a state in which an operation on a movable unit is accepted to a state in which the operation on the movable unit is not accepted for a predetermined time after receiving the synchronization information from the other communication device in a state in which the operation on the movable unit included in the communication device is accepted.
